(19) United States
(12) Patent Application Publication
(10) Pub. No.: US 2022/0320598 A1
(43) Pub. Date: Oct. 6, 2022

(54) RECHARGEABLE BATTERY ENDURANCE ENHANCING DEVICE

(71) Applicant: CHYURN SHAN INTERNATIONAL CO., LTD., Tainan City (TW)

(72) Inventor: I-I LIEN, TAINAN CITY (TW)

(21) Appl. No.: 17/684,380

(22) Filed: Mar. 1, 2022

(30) Foreign Application Priority Data
Mar. 30, 2021 (TW) 110111472
Mar. 30, 2021 (TW) 110203404

(51) Int. Cl. H01M 10/42; H01F 7/20; B01J 19/12

(52) U.S. Cl. CPC H01M 10/42; H01F 7/20; B01J 19/12

(57) ABSTRACT

This invention relates to a rechargeable battery endurance enhancing device, the body of which at least includes a power module, a frequency adjustment module and a emission module. Said power module is provided with a voltage stabilizing member, a conversion unit and a protection circuit, said voltage stabilizing member is used to provide stable voltage and current, said conversion unit can automatically convert the input voltage and current, and said protection circuit can protect said body from being damaged by abnormal current or abnormal voltage. Said frequency adjustment module is provided with a frequency adjustment member and an electromagnetic wave transmitter, said frequency adjustment member is used to control the wavelength and frequency of the emitted electromagnetic wave, and the command of said frequency adjustment member causes said electromagnetic wave transmitter to generate an electromagnetic wave with designated wavelength and frequency. Said emission module is provided with an amplifier and a transmitting member, said amplifier can amplify the power of the electromagnetic wave generated by the electromagnetic wave transmitter of said frequency adjustment module, and then transmit the electromagnetic wave amplified by said amplifier through said transmitting member. Said transmitting member is used to connect the outside of a chemical rechargeable battery and emit electromagnetic waves to the chemical substances inside said chemical rechargeable battery from the outside, so the molecular crystal structure of the chemical substance is broken and dissociated into an ionic state to trigger the charging chemical reaction until said chemical rechargeable battery returns to the best discharge state.

### CROSS-REFERENCE TO RELATED APPLICATIONS

This application claims the priority benefits to Taiwan patent application No. 110111472 filed on Mar. 30, 2021 and Taiwan patent application No. 110203404 filed on Mar. 30, 2021, the contents of the above identified applications are hereby incorporated by reference in its entirety.

### BACKGROUND OF THE INVENTION

### 1. Field of the Invention

This invention relates to a rechargeable battery endurance enhancing device, particularly to a device for enhancing the endurance of a chemical rechargeable battery.

### 2. Description of the Prior Art

In recent years, due to the rising issues of global warming, environmental awareness, air pollution, health and safety, many machinery, transportation tools and daily necessities have been gradually transformed into electrified equipment. Common fuel power equipment, gasoline-electric power equipment or electric power equipment, when it is used as a transportation device, a battery is required to provide power for its internal electronic device or motors. In rechargeable batteries, chemical battery (also known as electrochemical battery or electrochemical cell) refer to a type of device that converts the chemical energy of positive and negative active materials into electrical energy through redox reactions; the advantage of rechargeable battery (also known as secondary battery, secondary cell or accumulator) is that they can be recycled many times after charging, and the output current load capacity of rechargeable batteries is higher than most primary cells.

However, for rechargeable batteries containing electrolyte and the electrolyte is involved in chemical reactions (such as lead storage battery), the biggest problem in its use is that the battery life is too short (battery power decline due to incomplete charging and discharging), it needs to be replaced in an average of about 1 to 4 years, which makes the user need to spend a lot of money to maintain and replace the rechargeable battery. Furthermore, for some devices that are inconvenient to replace the battery, if the battery is not carefully replaced, it will cause the electronic equipment to burn, the maintenance personnel get an electric shock, or the battery on fire. In addition, if a large number of replaced waste batteries are not properly recycled, it will cause serious environmental pollution and cause serious harm to human health (for example, lead in lead-acid battery is a heavy metal that has a great impact on human health).

For this reason, in order to improve the use efficiency and battery life of the above-mentioned chemical rechargeable batteries, the inventor has accumulated many years of research and experimental test to solve the problems existing in the conventional chemical rechargeable batteries, and hence devised this invention.

### SUMMARY OF THE INVENTION

The purpose of the present invention is to provide an innovative rechargeable battery endurance enhancing device, this device can transmit electromagnetic wave of a specific frequency into a chemical rechargeable battery. When the energy of the electromagnetic wave is greater than the energy gap (that is, the energy level difference between the conductive band and the valence band) of the substance to be dissociated (such as lead sulfate in lead-acid battery), the excited electrons will jump to the position of high energy level, and are driven by the electric field of the electromagnetic wave to show simple harmonic motion (i.e. resonance effect or electromagnetic oscillation). At this moment, the excited electrons collide with lattice oscillation, when the energy of the oscillation and collision exceeds the binding force of the chemical bond, the molecular crystal structure inside the substance to be dissociated will crack, this will dissociate the substance to be dissociated into an ionic state and trigger a charging chemical reaction until the chemical rechargeable battery returns to its optimal discharge state. In this way, the chemical rechargeable battery can maintain the best charge-discharge efficiency, thereby improving the battery life and endurance of the chemical rechargeable battery, and minimizing the power decline of the chemical rechargeable battery.

The body of the rechargeable battery endurance enhancing device at least includes a power module, a frequency adjustment module and a emission module. Said power module is provided with a voltage stabilizing member, a conversion unit and a protection circuit, said voltage stabilizing member is used to provide stable voltage and current, said conversion unit can automatically convert the input voltage and current to provide the working voltage and current suitable for the operation of said body, and said protection circuit can protect said body from damage caused by abnormal current or abnormal voltage. Said frequency adjustment module is provided with a frequency adjustment member and an electromagnetic wave transmitter, said frequency adjustment member is used to control the wavelength and frequency of the emitted electromagnetic wave, and the command of said frequency adjustment member causes said electromagnetic wave transmitter to generate an electromagnetic wave with designated wavelength and frequency. Said emission module is provided with an amplifier and a transmitting member, said amplifier can amplify the power of the electromagnetic wave generated by the electromagnetic wave transmitter of said frequency adjustment module, and then transmit the electromagnetic wave amplified by said amplifier through said transmitting member. Said transmitting member is used to connect the outside of a chemical rechargeable battery and emit electromagnetic waves to the chemical substances inside said chemical rechargeable battery from the outside.

The rechargeable battery endurance enhancing device of present invention, among which said body can be connected to the positive electrode and the negative electrode of the chemical rechargeable battery, so as to supply the electric power of the body through the chemical rechargeable battery; or said body can be connected to an external power source.

The rechargeable battery endurance enhancing device of present invention, among which said emission module may be arranged on said body or extend to the outside of said body. When the emission module is arranged on said body, said body can be arranged below the chemical rechargeable battery, so that said body can maintain stable contact between said emission module and chemical rechargeable battery through the weight of said chemical rechargeable battery. When said emission module is provided outside said body, an anti-jamming member is arranged on said transmitting member, and said transmitting member can be attached to any position of said chemical rechargeable battery through said anti-jamming member, so that said transmitting member has an anti-jamming function.

### BRIEF DESCRIPTION OF DRAWINGS

This invention will be better understood by referring to the accompanying drawings, wherein:

FIG. 1 is a system structure diagram of the rechargeable battery endurance enhancing device in the present invention;

FIG. 2 is a schematic diagram of the rechargeable battery endurance enhancing device being powered by a chemical rechargeable battery; and

FIG. 3 is a schematic diagram of the rechargeable battery endurance enhancing device being powered by an external power source.

### DETAILED DESCRIPTION OF THE PREFERRED EMBODIMENT

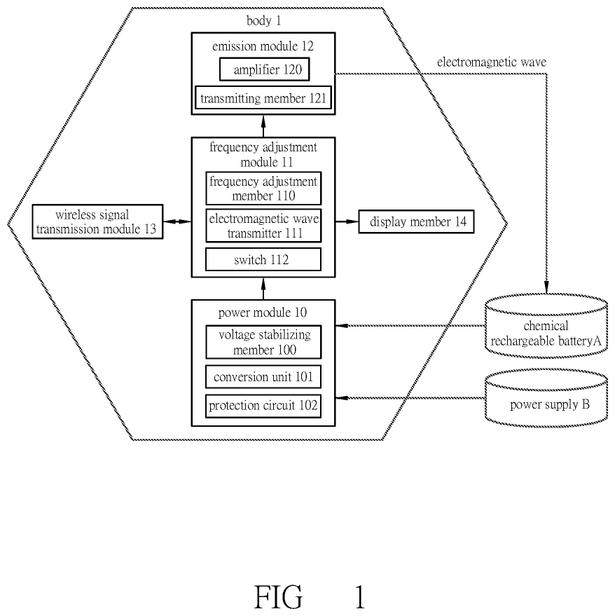

The preferred embodiments of a rechargeable battery endurance enhancing device in the present invention, as shown in FIGS. 1 to 3, the body 1 of said rechargeable battery endurance enhancing device at least includes a power module 10, a frequency adjustment module 11 and a emission module 12.

Said body 1 is made of a light, thin and high temperature resistant material, so that said body 1 can be easily carried and installed, and can protect the electronic components inside said body 1 in a high temperature environment (such as a car engine room).

Said power module 10 is provided with a voltage stabilizing member 100, a conversion unit 101 and a protection circuit 102. Said voltage stabilizing member 100 is used to provide stable voltage and current to ensure that said body 1 has a stable power input, said conversion unit 101 can automatically convert the input voltage and current to provide the operating voltage and current suitable for the operation of said body 1, and said protection circuit 102 can protect said body 1 from being damaged by abnormal current or abnormal voltage.

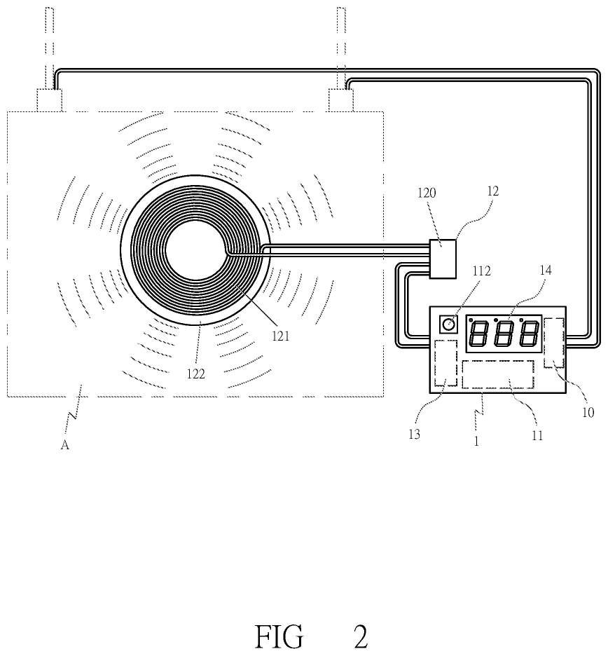

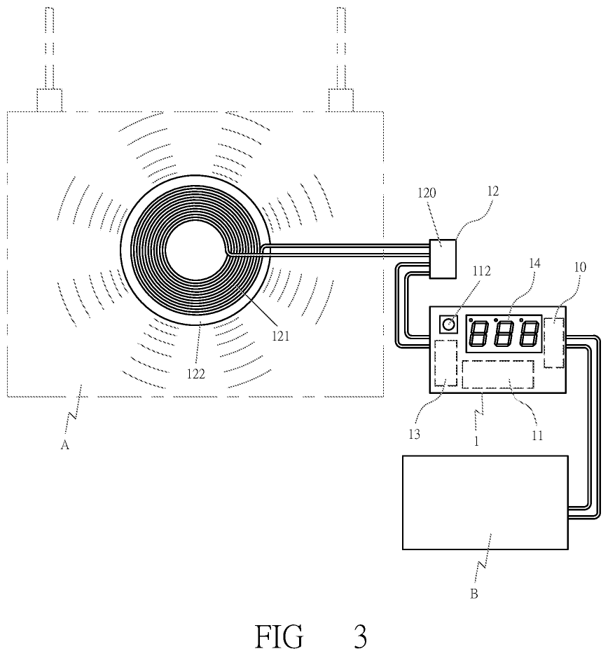

As shown in FIG. 2, said body 1 may be connected to the positive electrode and the negative electrode of a target chemical rechargeable battery A, so as to supply the power of said body 1 through the target chemical rechargeable battery A. Or as shown in FIG. 3, said body 1 may obtain the required power by connecting an external power supply B (battery, mobile power supply, power socket, etc.). For equipment with generator such as transportation, the power supply method in FIG. 2 can be used, and for equipment without generator, the power supply method in FIG. 3 is suitable.

Said frequency adjustment module 11 is provided with a frequency adjustment member 110 and an electromagnetic wave transmitter 111. Said frequency adjustment member 110 is used to control the wavelength and frequency of the emitted electromagnetic wave. By inputting different commands to said frequency adjustment member 110, said electromagnetic wave transmitter 111 will generate electromagnetic wave with specific wavelengths and frequencies suitable for various rechargeable batteries. Said frequency adjustment module 11 may be provided with a switch 112, and said switch 112 is used to switch the wavelength and frequency of electromagnetic wave suitable for different chemical rechargeable batteries. Therefore, when the rechargeable battery endurance enhancing device of the present invention is applied to various chemical rechargeable batteries, the user only needs to switch said switch 112 to make said frequency adjustment member 110 automatically adjust the wavelength and frequency of the output electromagnetic wave, and make said electromagnetic wave transmitter 111 emit electromagnetic wave suitable for the chemical rechargeable battery.

Said emission module 12 is provided with an amplifier 120 and a transmitting member 121, said amplifier 120 can amplify the power of the electromagnetic wave generated by said electromagnetic wave transmitter 111 to obtain sufficient oscillation energy (exceeding the chemical bonding force of the target molecule of said chemical rechargeable battery A). Said transmitting member 121 is used for emitting the electromagnetic wave amplified by said amplifier 120 to the outside, said transmitting member 121 is used to connect the outside of said chemical rechargeable battery and emit electromagnetic waves to the chemical substances inside said chemical rechargeable battery A from the outside, then the electromagnetic wave with specific frequency will crack and dissociate the molecular crystal structure of the target molecule of the chemical rechargeable battery A into an ionic state. Said emitting module 12 may be arranged on said body 1 or extend to the outside of said body 1. When said emission module 12 is arranged on said body 1, said body 1 can be arranged below said chemical rechargeable battery A, so that said body 1 can maintain stable contact between said emission module 12 and chemical rechargeable battery A through the weight of said chemical rechargeable battery A. As shown in FIGS. 2 and 3, when said emission module 12 is provided outside said body 1, an anti-jamming member 122 is arranged on said transmitting member 121. Said anti-jamming member 122 may be an anti-jamming patch, so that said transmitting member 121 can be attached to any position of said chemical rechargeable battery A, and said transmitting member 121 will have an anti-jamming function.

Said body 1 may be provided with a wireless signal transmission module 13, such as a bluetooth module or a WIFI module, through said wireless signal transmission module 13, said body 1 can be connected to a control system of the user's smart phone, tablet computer, computer, car computer or other equipment. In this way, the user can monitor the operation of the rechargeable battery endurance enhancing device at any time through his mobile device, and even turn said rechargeable battery endurance enhancing device on or off through remote control.

Said body 1 may be provided with a display member 14, said display member 14 may be an LED indicator light, a display screen or a touch display screen, said display member 14 can display the operating status of said body 1 so as to facilitate the user to judge the operating status of said body 1. For example, when said display member 14 is an LED indicator light, the user can judge whether said body 1 is in a working state through the display state of the LED indicator light, and it is convenient for the user to judge whether said body 1 is running normally (green light), error (yellow light), Component damage (red light) or abnormal temperature (blue light), etc. When said display member 14 is a touch display screen, the user can read the operation status of said body 1 through the touch display screen, or various functions of said body 1 can be set.

In this way, the rechargeable battery endurance enhancing device of the present invention can be directly arranged on a chemical rechargeable battery A of a transportation, or can be used alone on a chemical rechargeable battery A. The user can connect the power source of body 1 of the rechargeable battery endurance enhancing device to the target chemical rechargeable battery A, or connect an external power source B, depending on the usage conditions. When the body 1 is activated, the transmitting member 121 of the emitting module 12 will emit an electromagnetic wave with specific frequency to the target chemical rechargeable battery A.

When the energy of the electromagnetic wave is greater than the energy gap of the substance to be dissociated, the excited electrons will jump to the position of high energy level, and are driven by the electric field of the electromagnetic wave to show simple harmonic motion (i.e. resonance effect or electromagnetic oscillation). At this moment, the excited electrons collide with lattice oscillation, when the energy of the oscillation and collision exceeds the binding force of the chemical bond, the molecular crystal structure inside the substance to be dissociated will crack, this will dissociate the substance to be dissociated into an ionic state and trigger a charging chemical reaction until the chemical rechargeable battery returns to its optimal discharge state.

After the actual test of the inventor of the present invention, it is known that, when a fully charged lead-acid battery (The lead-acid battery model used in this experiment is YUASA's YTX5L-BS) is connected to a 21-watt LED bulb for 1-hour discharge test and measure the voltage and current before and after discharge, the measured voltage drop ratio before and after discharge is 4%, and the current drop ratio before and after discharge is 20.48%. When the same lead-acid battery is connected to the rechargeable battery endurance enhancing device of the present invention and optimized, then connect the fully charged lead-acid battery to the same 21-watt LED bulb for 1-hour discharge test and measure the voltage and current before and after discharge, the measured voltage drop ratio before and after discharge is 2.58%, and the current drop ratio before and after discharge is 5.98%. For chemical rechargeable battery with more severe power decline, the effect of increasing the endurance is more significant.

In summary, the rechargeable battery endurance enhancing device of the present invention can indeed keep the chemical rechargeable battery with the best charging and discharging efficiency, and improve the endurance and service life of the chemical rechargeable battery. Moreover, the present invention can minimize the power decline of the chemical rechargeable battery, so as to improve its endurance, environmental protection and economic benefits.

While the preferred embodiments of this invention have been described above, it will be recognized and understood that various modifications may be made therein and appended claims are intended to cover all such modifications that may fall within the spirit and scope of the invention.

What is claimed is:

1. A rechargeable battery endurance enhancing device at least comprising:
a body is provided with a power module, a frequency adjustment module and an emission module;
said power module is provided with a voltage stabilizing member, a conversion unit and a protection circuit, said voltage stabilizing member is used to provide stable voltage and current, said conversion unit automatically converts the input voltage and current to provide the working voltage and current suitable for the operation of said body, and said protection circuit is used to protect said body from damage caused by abnormal current or abnormal voltage;
said frequency adjustment module is provided with a frequency adjustment member and an electromagnetic wave transmitter, said frequency adjustment member is used to control the wavelength and frequency of the emitted electromagnetic wave, and the command of said frequency adjustment member causes said electromagnetic wave transmitter to generate an electromagnetic wave with designated wavelength and frequency;
said emission module is provided with an amplifier and a transmitting member, said amplifier is used to amplify the power of the electromagnetic wave generated by the electromagnetic wave transmitter of said frequency adjustment module, then transmit the electromagnetic wave amplified by said amplifier through said transmitting member; said transmitting member is used to connect the outside of a chemical rechargeable battery and emit electromagnetic waves to the chemical substances inside said chemical rechargeable battery from the outside.

2. The rechargeable battery endurance enhancing device as claimed in claim 1, wherein said body is made of a light, thin and high temperature resistant material.

3. The rechargeable battery endurance enhancing device as claimed in claim 1, wherein said body is connected to the positive electrode and the negative electrode of said chemical rechargeable battery, so as to supply the power of said body through said chemical rechargeable battery.

4. The rechargeable battery endurance enhancing device as claimed in claim 1, wherein said body obtains the required power by connecting an external power supply.

5. The rechargeable battery endurance enhancing device as claimed in claim 1, wherein said frequency adjustment module is provided with a switch, and said switch is used to switch the wavelength and frequency of electromagnetic waves suitable for different chemical rechargeable batteries.

6. The rechargeable battery endurance enhancing device as claimed in claim 1, wherein said emission module is arranged on said body, said body is arranged below said chemical rechargeable battery, so that said body maintains stable contact between said emission module and chemical rechargeable battery through the weight of said chemical rechargeable battery.

7. The rechargeable battery endurance enhancing device as claimed in claim 1, wherein said emission module is provided outside said body, an anti-jamming member is arranged on said transmitting member.

8. The rechargeable battery endurance enhancing device as claimed in claim 7, wherein said anti-jamming member is an anti-jamming patch.

9. The rechargeable battery endurance enhancing device as claimed in claim 1, wherein said body is provided with a wireless signal transmission module.

10. The rechargeable battery endurance enhancing device as claimed in claim 1, wherein said body is provided with a display member.
